(19) United States
(12) Patent Application Publication
(10) Pub. No.: US 2013/0205740 A1
(43) Pub. Date: Aug. 15, 2013

(54) Push Rake

(71) Applicant: Michael L. JORDAN, Flowood, MS (US)

(72) Inventor: Michael L. JORDAN, Flowood, MS (US)

(21) Appl. No.: 13/369,875

(22) Filed: Feb. 9, 2012

(51) Int. Cl. A01D 7/00

(52) U.S. Cl. 56/400.16

(57) ABSTRACT

A push rake with a sliding cylinder handle member that is movable along the long central axis of the elongated shaft member. A user, by grasping the handle of the sliding cylinder member with one hand, and grasping the elongated shaft member at a point closer to the distal end than the proximal end, moves the raking face along the raking surface in the direction in which the raking face is oriented by pushing the push rake, rather than pulling it.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of Invention

This invention pertains generally to horticultural and gardening implements. More particularly, this invention pertains to an improved lawn rake having a configuration adapted to be operably pushed rather than pulled.

2. Description of the Related Art

A number of hand rake configurations have been proposed and implemented to date incorporating various designs and materials. Such rakes are typically utilized in yards to rake leaves, grass clippings, and the like. Recent rake designs have focused on assisting the user in maintaining a comfortable and substantially upright stance during the raking process. Nevertheless, conventional yard rakes require a pulling motion for effective raking. Such rake designs fail to optimize user comfort and fail to effectively provide a mechanism for the user to perform the raking process through a pushing motion.

Known in the art are the following patents and published patent applications:

| Pat. No. | Inventor(s) | Date of Issue |
|---|---|---|
| 658,831 | Danielsen | Oct. 2, 1900 |
| 757,061 | Shirk et al. | Apr. 12, 1904 |
| 813,569 | Miller | Feb. 27, 1906 |
| 2,329,708 | Fetterman | Sep. 21, 1943 |
| 2,647,356 | Adams | Aug. 4, 1953 |
| 4,516,393 | Lambert | May 14, 1985 |
| 4,970,853 | Greene, III | Nov. 20, 1990 |
| 6,918,240 | Hurt | Jul. 19, 2005 |

| Pub. Pat. App. | Inventor(s) | Date of Publication |
|---|---|---|
| 2003/0188523 | Geremia | Oct. 9, 2003 |
| 2004/0031116 | Coleman | Feb. 19, 2004 |
| 2004/0187470 | Hurt | Sep. 30, 2004 |
| 2005/0193710 | Shen | Sep. 8, 2005 |
| 2007/0289283 | Hanas | Dec. 20, 2007 |

It is desirable to have a rake design that maximizes user comfort and transmission of energy to the raking surface and that is configured for providing an effective raking capability as the user pushes the yard rake away from the user's body.

### BRIEF SUMMARY OF THE INVENTION

In some of its many embodiments, the present general inventive concept comprises a rake in which the raking action of the rake—that is, the action by which the rake head engages with objects on a raking surface and moves them to a desired location—is accomplished by a user pushing rather than pulling the rake. The present general inventive concept, in some of its several embodiments, comprises a push rake with an elongated shaft member having a central axis, a proximal end, and a distal end; a rake head having a plurality of tines arranged substantially along a plane substantially transversely aligned with respect to the central axis of the elongated shaft member, the rake head being detachably connected to the proximal end of the elongated shaft member. The rake head defines a raking face on a first side of the plane to engage a raking surface; this raking face is substantially oriented in a direction away from a greater part of the elongated shaft member. Additionally, in many embodiments, a sliding cylinder member is positioned on the elongated shaft member; this sliding cylinder member is movable along the central axis of the elongated shaft member, and generally includes a handle protruding from the sliding cylinder member. A user, by grasping the handle of the sliding cylinder member with one hand, and grasping the elongated shaft member at a point closer to the distal end than the proximal end, moves the raking face along the raking surface in the direction in which the raking face is oriented by pushing the push rake, rather than pulling it.

In some of its several embodiments, present general inventive provides a rake design that maximizes user comfort and facilitates the transmission of energy to the raking surface. In some example embodiments, a push rake according to the present general inventive concept is configured for providing an effective raking capability as the user pushes the rake away from the user's body.

### BRIEF DESCRIPTION OF THE DRAWINGS

The above-mentioned and additional features of the invention will become more clearly understood from the following detailed description of the invention read together with the drawings in which:

FIG. 1 is a perspective view of one example embodiment of push rake according to the present general inventive concept;

FIG. 2 is another perspective view of the example embodiment shown in FIG. 1, showing the movement of the elongated shaft member relative to the sliding cylinder member;

FIG. 3 is a close-up perspective view of the rake head of the example embodiment shown in FIGS. 1 and 2, showing the rake head connected to the elongated shaft member;

FIG. 4 is another close-up perspective view of the rake head shown in FIG. 3, showing the rake head detached from the elongated shaft member; and

FIG. 5 is a view of the elongated shaft member of the example embodiment shown in FIG. 1 with a different end member substituted for the detachable rake head.

### DETAILED DESCRIPTION OF THE INVENTION

In some of its many embodiments, the present general inventive concept comprises a push rake with a sliding cylinder handle member that is movable along the long central axis of the elongated shaft member. A user, by grasping the handle of the sliding cylinder member with one hand, and grasping the elongated shaft member at a point closer to the distal end than the proximal end, moves the raking face along the raking surface in the direction in which the raking face is oriented by pushing the push rake, rather than pulling it.

In some embodiments, the present general inventive concept comprises a rake device that includes an elongated shaft member having a central axis; a rake head having a plurality of tines arranged substantially along a plane substantially transversely aligned with respect to the central axis of the elongated shaft member, with the rake head defining a face on a first side of said plane to engage a raking surface, said face on the first side of said plane substantially oriented away from a greater part of said elongated shaft member; a bracket member connecting said rake head to said elongated shaft member; and a sliding cylinder member positioned on said elongated shaft member, said sliding cylinder member being movable along the central axis of said elongated shaft member.

In some embodiments, the present general inventive concept comprises a rake in which the raking action of the rake—that is, the action by which the rake head engages with objects on a raking surface and moves them to a desired location—is accomplished by a user pushing rather than pulling the rake. The present general inventive concept, in some of its several embodiments, comprises a push rake with an elongated shaft member having a central axis, a proximal end, and a distal end; a rake head having a plurality of tines arranged substantially along a plane substantially transversely aligned with respect to the central axis of the elongated shaft member, the rake head being detachably connected to the proximal end of the elongated shaft member. The rake head defines a raking face on a first side of the plane to engage a raking surface; this raking face is substantially oriented in a direction away from a greater part of the elongated shaft member. Additionally, in many embodiments, a sliding cylinder member is positioned on the elongated shaft member; this sliding cylinder member is movable along the central axis of the elongated shaft member, and generally includes a handle protruding from the sliding cylinder member. A user, by grasping the handle of the sliding cylinder member with one hand, and grasping the elongated shaft member at a point closer to the distal end than the proximal end, moves the raking face along the raking surface in the direction in which the raking face is oriented by pushing the push rake, rather than pulling it.

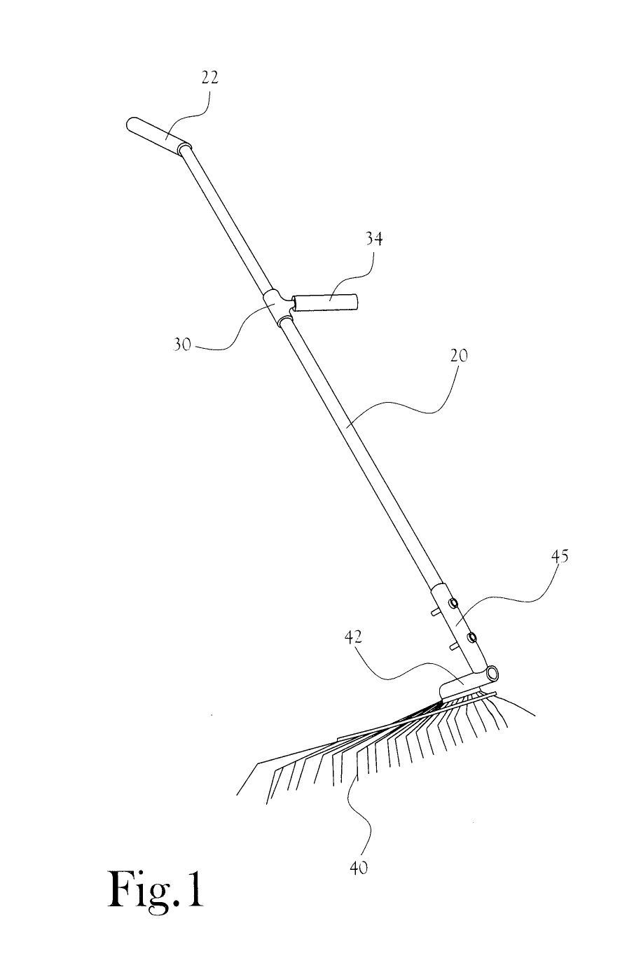

One example embodiment of the present general inventive concept is illustrated generally in FIG. 1. As shown in FIG. 1, a push rake 10 comprises an elongated shaft member 20, a sliding cylinder member 30, and a rake head 40. In several embodiments, the elongated shaft member 20 is substantially cylindrical, has a central axis, and posses what is defined as a proximal end and a distal end. Often, and in the illustrated example embodiment, the elongated shaft member 20 includes an end handle 22 at its distal end. The sliding cylinder member 30 fits around the circumference of the elongated shaft member 20 and is movable along the central axis of the substantially cylindrical elongated shaft member 20. The sliding cylinder member 30 generally includes a handle 34 protruding at an angle from the sliding cylinder member 30 and away from the axis of the elongated shaft member 20; this handle 34 permits a user more easily to secure a hold on the sliding cylinder member 30 when the elongated shaft member 20 is moved with respect to the sliding cylinder member 30. The rake head 40 is connected to the proximal end of the elongated shaft member 20. The rake head 40 generally includes a plurality of tines arranged substantially along a single plane, the plane being substantially transversely aligned with respect to the central axis of the elongated shaft member 20—that is, most of the tines of the rake head 40 are substantially perpendicular to the central axis of the elongated shaft member 20; or most of the tines of the rake head 40 form an acute angle with the central axis of the elongated shaft member 20, the acute angle nevertheless being at least 30 degrees; or most of the tines of the rake head 40 form an acute angle with the central axis of the elongated shaft member 20, the angle nevertheless being less than 150 degrees.

Generally, the rake head 40 defines a face on a first side of the plane in which the tines lie. This face (or “raking face”) engages with a raking surface to interact with objects on a raking surface and move such objects (like leaves, for instance). As the push rake 10 is designed to be operated by a user pushing the push rake 10 away from the user's body, the raking face of the rake head 40 is substantially oriented away from a greater part of the elongated shaft member 20, where the user will be holding the push rake.

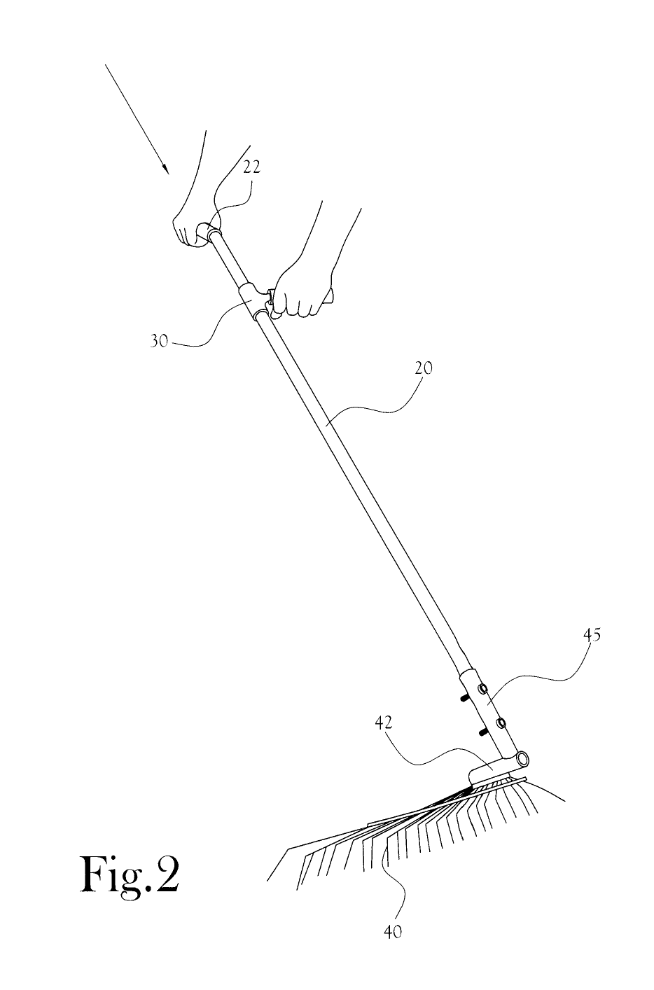

As shown in FIG. 2, to operate the push rake 10, a user grasps the handle 34 of the sliding cylinder member 30 with one hand, grasps the end handle 22 of the elongated shaft member 20, and pushes the elongated shaft member 20 forward, so that the elongated shaft member 20 slides forward through the sliding cylinder member 30. The forward movement of the elongated shaft member 20 moves the raking face of the rake head 40 along the raking surface in the direction in which the raking face is oriented. Thus the user moves the raking face along the raking surface, and engages with objects on the raking surface (such as leaves, for example), by pushing the rake, rather than pulling it. The sliding cylinder member 30 and its protruding handle 34 allow the user to hold one arm stable while the other arm (with the hand grasping the end handle 22 of the elongated shaft member 20) moves, giving the user superior control over the push rake 10 and making use of the push rake 10 less stressful and exhausting for the user than a conventional pull rake.

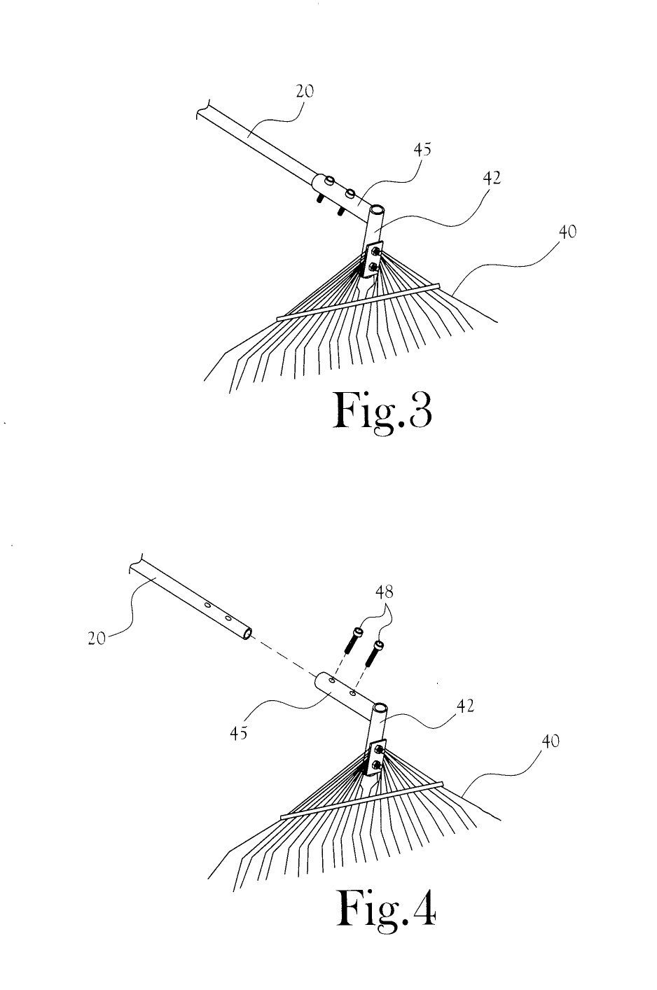

As shown in FIGS. 1 and 2, and as shown in the close-up views in FIG. 3 and FIG. 4, in the illustrated example embodiment, as in many other embodiments, the rake head 40 is connected to the elongated shaft member 20 through a bracket member 45. In the illustrated example embodiment, the rake head 40 is connected to a dowel 42, which is connected to the bracket member 45, which is detachably connected to the elongated shaft member 20 and is secured to the elongated shaft member 20 by bolts 48 or similar fastening devices. The dowel 42 and bracket member 45, through the angle of their connection, to place the tines of the rake head 40 in a plane substantially transverse to the long central axis of the elongated shaft member 20.

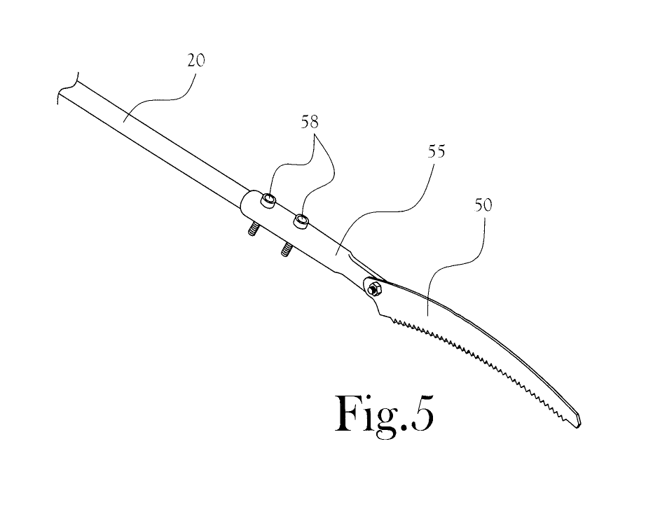

In the illustrated example embodiment, and in many other embodiments of the present general inventive concept, the rake head 40 is detachable from the elongated shaft member 20. FIG. 5 illustrates one example of a substitute head member for the device. In the illustrated example, the rake head 40 has been removed and replaced with a saw head 50, which is connected to the elongated shaft member 20 through a bracket member 55 and bolts 58 or similar fastening devices. With a saw head 50, the device is useful for a number of purposes, such as cutting branches high in a tree—branches that would otherwise be difficult to reach. In other examples, a number of heads for the device are contemplated, including, for example, paint rollers a broom heads.

In some of its several embodiments, present general inventive provides a rake design that maximizes user comfort and facilitates the transmission of energy to the raking surface. In some example embodiments, a push rake according to the present general inventive concept is configured for providing an effective raking capability as the user pushes the rake away from the user's body.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A rake device comprising:
an elongated shaft member having a central axis;
a rake head having a plurality of tines arranged substantially along a plane substantially transversely aligned with respect to the central axis of said elongated shaft member, said rake head defining a face on a first side of said plane to engage a raking surface, said face on the first side of said plane substantially oriented away from a greater part of said elongated shaft member;
a bracket member connecting said rake head to said elongated shaft member; and
a sliding cylinder member positioned on said elongated shaft member, said sliding cylinder member being movable along the central axis of said elongated shaft member.

2. The rake device of claim 1 wherein said rake head and said bracket member are detachable from said elongated shaft member.

3. The rake device of claim 1 wherein said sliding cylinder member includes a handle protruding from the sliding cylinder member.

4. A push rake comprising:
an elongated shaft member having a central axis, a proximal end, and a distal end;
a rake head having a plurality of tines arranged substantially along a plane substantially transversely aligned with respect to the central axis of said elongated shaft member, said rake head being detachably connected to the proximal end of said elongated shaft member, said rake head defining a raking face on a first side of said plane to engage a raking surface, said raking face on the first side of said plane substantially oriented in a direction away from a greater part of said elongated shaft member; and
a sliding cylinder member positioned on said elongated shaft member, said sliding cylinder member being movable along the central axis of said elongated shaft member, a handle protruding from the sliding cylinder member;
whereby a user, by grasping the handle of the sliding cylinder member with one hand, and grasping the elongated shaft member at a point closer to the distal end than the proximal end, moves the raking face along the raking surface in the direction in which the raking face is oriented by pushing the push rake.

5. A multi-use push device comprising:
an elongated shaft member having a central axis, a proximal end, and a distal end;
a detachable head member to connect to the proximal end of said elongated shaft member; and
a sliding cylinder member positioned on said elongated shaft member, said sliding cylinder member being movable along the central axis of said elongated shaft member, a handle protruding from the sliding cylinder member;
whereby a user, by grasping the handle of the sliding cylinder member with one hand, and grasping the elongated shaft member at a point closer to the distal end than the proximal end, moves the detachable head member with a pushing motion.

6. The rake device of claim 5 wherein the detachable head member is selected from the group consisting of a rake head, a saw head, a paint roller, and a broom head.
